(19) United States
(12) Patent Application Publication
(10) Pub. No.: US 2026/0145201 A1
(43) Pub. Date: May 28, 2026

(54) ELECTROSTATIC FILM-FORMING APPARATUS

(71) Applicant: BERG INDUSTRY CO., LTD., Saitama (JP)

(72) Inventor: Kesao ANDO, Saitama (JP)

(21) Appl. No.: 19/206,711

(22) Filed: May 13, 2025

(30) Foreign Application Priority Data
May 17, 2024 (JP) 2024-080960

(51) Int. Cl. B05C 19/06; B05C 19/00; B08B 5/04; B65G 45/10

(52) U.S. Cl. CPC B05C 19/06; B05C 19/002; B08B 5/046; B65G 45/10

(57) ABSTRACT

An improved electrostatic film-forming apparatus that employs a rubbing belt instead of a conventional roll brush is disclosed. The electrostatic film-forming apparatus is configured to deposit powder onto an object by electrostatic force. The electrostatic film-forming apparatus comprises: a screen having a mesh formed thereon; a rubbing belt configured to rub the powder into the screen; a pressing head configured to press the rubbing belt against the screen; a belt moving mechanism configured to move the rubbing belt in its longitudinal direction; a power source configured to apply a voltage between the screen and the object; and a hopper configured to supply the powder to the rubbing belt or the screen.

### CROSS REFERENCE TO RELATED APPLICATION

This document claims priority to Japanese Patent Application No. 2024-080960 filed May 17, 2024, the entire contents of which are hereby incorporated by reference.

### BACKGROUND

Electrostatic screen printing apparatuses are used for various purposes, such as printing on food products and manufacturing industrial products. The principle of this electrostatic printing will be described with reference to FIG. 33. As shown in FIG. 33, an electrostatic screen printing apparatus includes a conveyor 501 on which an object 500 is placed, a screen 502 having a mesh, a roll brush 503 on the screen 502, and a hopper 504 that supplies powder to the roll brush 503. The object 500 is moved by the convey or 501 to a printing position below the screen 502.

The screen 502 is coupled to a negative electrode of a power supply DC, and the conveyor 501 is coupled to a positive electrode of the power supply DC and is grounded. A high voltage is applied between the screen 502 and the conveyor 501 by the power supply DC, thereby generating an electrostatic field between the screen 502 and the object 500 on the conveyor 501.

The powder is supplied from the hopper 504 onto the rotating roll brush 503, and then falls onto the screen 502. The powder on the screen 502 is rubbed into the mesh of the screen 502 by the rotating roll brush 503, passes through the mesh and is pushed out from a bottom of the screen 502. At this time, the powder is negatively charged due to friction with the rotating roll brush 503. Therefore, the powder is attracted to the grounded object 500 and adheres to a surface of the object 500, forming a film of uniform thickness on the object 500.

Such electrostatic printing technique is capable of forming a uniform powder film. Therefore, the electrostatic printing technique has recently been used in manufacturing of a variety of industrial products, such as fuel cell, all-solid-state battery, secondary battery, and cosmetic product.

### SUMMARY

An improved electrostatic film-forming apparatus is provided that employs a rubbing belt instead of a conventional roll brush.

Embodiments, which will be described below, relate to an electrostatic film-forming apparatus configured to deposit powder, such as an edible powder or a functional powder, onto an object by utilizing electrostatic force.

In an embodiment, there is provided an electrostatic film-forming apparatus for depositing powder onto an object by electrostatic force, comprising: a screen having a mesh formed thereon; a rubbing belt configured to rub the powder into the screen; a pressing head configured to press the rubbing belt against the screen; a belt moving mechanism configured to move the rubbing belt in its longitudinal direction; a power source configured to apply a voltage between the screen and the object; and a hopper configured to supply the powder to the rubbing belt or the screen.

In an embodiment, the rubbing belt is an endless belt, and the belt moving mechanism has a driving pulley and a driven pulley that support the rubbing belt, and a pulley rotating mechanism configured to rotate the driving pulley.

In an embodiment, the hopper is located above the rubbing belt and is arranged to supply the powder onto the rubbing belt.

In an embodiment, the electrostatic film-forming apparatus further comprises a powder leveling member configured to level the powder supplied from the hopper to the rubbing belt.

In an embodiment, the electrostatic film-forming apparatus further comprises a belt vibrating device configured to vibrate the rubbing belt together with the powder supplied from the hopper to the rubbing belt.

In an embodiment, the electrostatic film-forming apparatus further comprises a belt cover configured to prevent the powder, supplied from the hopper to the rubbing belt, from falling from the rubbing belt, the belt cover having a powder guide surface extending along an outer surface of the rubbing belt.

In an embodiment, the electrostatic film-forming apparatus further comprises a charge eliminator configured to eliminate electric charge from the powder supplied from the hopper to the rubbing belt.

In an embodiment, the electrostatic film-forming apparatus further comprises an electric-charge applying device configured to apply electric charge to the powder supplied from the hopper to the rubbing belt.

In an embodiment, the electrostatic film-forming apparatus further comprises a vacuum suction device configured to remove the powder from the rubbing belt that has passed through the pressing head.

In an embodiment, the electrostatic film-forming apparatus further comprises a pressing regulation mechanism configured to move the pressing head in a direction toward the screen and in a direction away from the screen.

In an embodiment, the pressing regulation mechanism includes a tilting actuator configured to tilt the pressing head relative to the screen.

In an embodiment, the tilting actuator is configured to tilt the pressing head in the longitudinal direction of the rubbing belt.

In an embodiment, the tilting actuator is configured to tilt the pressing head in a width direction of the rubbing belt.

In an embodiment, the pressing head comprises a plurality of pressing heads, and the pressing regulation mechanism comprises a plurality of pressing regulation mechanisms coupled to the plurality of pressing heads, respectively.

In an embodiment, the electrostatic film-forming apparatus further comprises a translation mechanism configured to move the pressing head along the screen, the translation mechanism being disposed so as to move the pressing head relative to the rubbing belt.

In an embodiment, the screen comprises a first screen and a second screen arranged above and below the object, the rubbing belt comprises a first rubbing belt and a second rubbing belt arranged above and below the object, the pressing head comprises a first pressing head and a second pressing head arranged above and below the object, the belt moving mechanism comprises a first belt moving mechanism and a second belt moving mechanism arranged above and below the object, and the hopper comprises a first hopper and a second hopper arranged above the first rubbing belt and the second rubbing belt.

In an embodiment, the screen comprises a first screen and a second screen arranged at both sides of the object, the rubbing belt comprises a first rubbing belt and a second rubbing belt arranged at both sides of the object, the pressing head comprises a first pressing head and a second pressing head arranged at both sides of the object, the belt moving mechanism comprises a first belt moving mechanism and a second belt moving mechanism arranged at both sides of the object, and the hopper comprises a first hopper and a second hopper arranged above the first rubbing belt and the second rubbing belt.

In an embodiment, the hopper comprises a plurality of hoppers disposed above the rubbing belt.

In an embodiment, the electrostatic film-forming apparatus further comprises: a first moving mechanism configured to move the rubbing belt, the pressing head, and the belt moving mechanism together parallel to the screen; and a second moving mechanism configured to move the hopper parallel to the screen.

In an embodiment, the rubbing belt comprises a belt having ends, and the belt moving mechanism is configured to reciprocate the rubbing belt in its longitudinal direction.

The rubbing belt has a larger contact area with the screen than a contact area of the roll brush 503 shown in FIG. 33, and can therefore rub the powder into the screen over a wider area. As a result, the efficiency of electrostatic application of powder is improved, and electrostatic application of powder can be completed in a shorter time. In addition, since the contact area between the rubbing belt and the screen is large, the screen is less likely to bend. As a result, a distance between the screen and the object can be uniform, so that a uniform electrostatic field can be formed between the screen and the object. In addition, a service life of the screen is expected to increase.

The rubbing belt has a larger surface area than that of the roll brush 503 shown in FIG. 33. Therefore, the powder on the rubbing belt can be leveled before the powder is rubbed into the screen, or excess powder on the rubbing belt can be removed by a vacuum suction device after the powder has been rubbed into the screen.

### BRIEF DESCRIPTION OF THE DRAWINGS

FIG. 1 is a front view showing an embodiment of an electrostatic film-forming apparatus;

FIG. 2 is a side view of the electrostatic film-forming apparatus shown in FIG. 1;

FIG. 3 is a front view showing another embodiment of the electrostatic film-forming apparatus;

FIG. 4 is a side view of the electrostatic film-forming apparatus shown in FIG. 3;

FIG. 5 is a diagram showing a state in which a pressing regulation mechanism moves a pressing head via a support member in a direction away from a screen;

FIG. 6 is a front view showing another embodiment of the electrostatic film-forming apparatus;

FIGS. 7A and 7B are diagrams illustrating operations of two tilting actuators;

FIG. 8 is a front view showing another embodiment of the electrostatic film-forming apparatus;

FIG. 9 is a front view showing another embodiment of the electrostatic film-forming apparatus;

FIG. 10 is a front view showing another embodiment of the electrostatic film-forming apparatus;

FIG. 11 is a front view showing another embodiment of the electrostatic film-forming apparatus;

FIG. 12 is a front view showing another embodiment of the electrostatic film-forming apparatus;

FIG. 13 is a diagram showing an embodiment of a pressing regulation mechanism shown in FIG. 10;

FIG. 14 is a front view showing another embodiment of the electrostatic film-forming apparatus;

FIG. 15 is a front view showing another embodiment of the electrostatic film-forming apparatus;

FIG. 16 is a front view showing another embodiment of the electrostatic film-forming apparatus;

FIG. 17 is a front view showing another embodiment of the electrostatic film-forming apparatus;

FIG. 18 is a front view showing another embodiment of the electrostatic film-forming apparatus;

FIG. 19 is a front view showing another embodiment of the electrostatic film-forming apparatus;

FIG. 20 is a front view showing another embodiment of the electrostatic film-forming apparatus;

FIGS. 21A and 21B are front views each showing another embodiment of the electrostatic film-forming apparatus;

FIG. 22 is a front view showing another embodiment of the electrostatic film-forming apparatus;

FIG. 23 is a front view showing another embodiment of the electrostatic film-forming apparatus;

FIG. 24 is a front view showing another embodiment of the electrostatic film-forming apparatus;

FIGS. 25A and 25B are side views of the electrostatic film-forming apparatus shown in FIG. 24;

FIG. 26 is a diagram illustrating an operation of a second moving mechanism configured to move a hopper above a screen;

FIG. 27 is a diagram illustrating an operation of a first moving mechanism configured to move a rubbing belt, a pressing head, and a belt moving mechanism along the screen;

FIG. 28 is a front view showing another embodiment of the electrostatic film-forming apparatus;

FIG. 29 is a side view of the electrostatic film-forming apparatus shown in FIG. 28;

FIG. 30 is a front view showing an embodiment of a rubbing belt;

FIG. 31 is a cross-sectional view taken along line A-A in FIG. 30;

FIG. 32 is a front view showing another embodiment of the electrostatic film-forming apparatus; and

FIG. 33 is a schematic diagram showing a conventional electrostatic film-forming apparatus.

### DESCRIPTION OF EMBODIMENTS

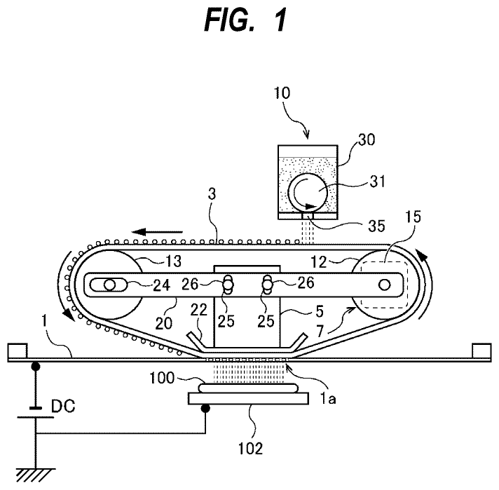

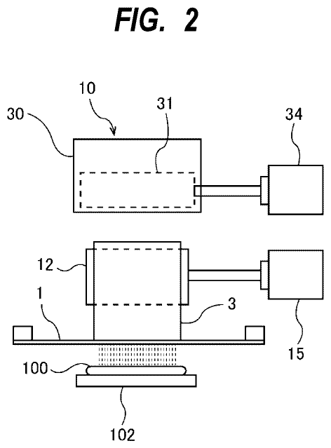

Hereinafter, embodiments will be described with reference to the drawings. FIG. 1 is a front view showing an embodiment of an electrostatic film-forming apparatus, and FIG. 2 is a side view of the electrostatic film-forming apparatus shown in FIG. 1. The electrostatic film-forming apparatus includes a screen 1 having a mesh la formed therein, a rubbing belt 3 configured to rub powder into the screen 1, a pressing head 5 configured to press the rubbing belt 3 against the screen 1, a belt moving mechanism 7 configured to move the rubbing belt 3 in its longitudinal direction, a power source DC configured to apply a voltage between the screen 1 and an object 100, and a hopper 10 configured to supply the powder onto the rubbing belt 3. Examples of the powder include edible powder and functional powder. The object 100 is not particularly limited and may be food, or industrial product, such as fuel cell, all-solid-state battery, secondary battery, and cosmetic product. Electrostatic film formation includes electrostatic application.

The screen 1 is disposed above the object 100. The mesh la of the screen 1 forms a plurality of through-holes that allow the powder to pass therethrough. The hopper 10 is disposed above the rubbing belt 3 and is disposed so as to supply the powder onto the rubbing belt 3. The rubbing belt 3 of this embodiment is an endless belt. The belt moving mechanism 7 has a driving pulley 12 and a driven pulley 13 that support an inside of the rubbing belt 3, and a pulley rotating mechanism 15 configured to rotate the driving pulley 12. The pulley rotating mechanism 15 is coupled to the driving pulley 12. The pulley rotating mechanism 15 includes a motor and a torque transmission mechanism (for example, a sprocket, a chain, etc.). The pulley rotating mechanism 15 may be composed of a motor directly coupled to the driving pulley 12.

The driving pulley 12 and the driven pulley 13 are rotatably supported by a support member 20. The support member 20 extends horizontally, and the driving pulley 12 and the driven pulley 13 are supported on both ends of the support member 20. A first oblong hole 24 is formed in one end of the support member 20. A shaft of the driven pulley 13 is inserted into the first oblong hole 24 and is movable in a longitudinal direction of the first oblong hole 24. The driven pulley 13 is pushed in a direction away from the driving pulley 12 by a spring (not shown) so as to apply tension to the rubbing belt 3. The driven pulley 13 in this embodiment functions as a tension pulley that applies the tension to the rubbing belt 3.

The pressing head 5 is disposed so as to press the rubbing belt 3 from its inner side against the screen 1. The pressing head 5 has a pressing plate 22 which comes into contact with an inner surface of the rubbing belt 3. The pressing plate 22 has a contact surface which is in contact with the rubbing belt 3. This contact surface of the pressing plate 22 may preferably be made of a material with low friction resistance, such as Teflon (registered trademark).

The pressing head 5 is held by the support member 20. More specifically, the support member 20 has second oblong holes 25 extending in a direction perpendicular to the screen 1. The pressing head 5 is fixed to the support member 20 by screws 26 passing through the second oblong holes 25. When the screws 26 are loosened, the pressing head 5 becomes movable in the direction perpendicular to the screen 1. Therefore, a position of the pressing head 5 with respect to the screen 1 can be adjusted by the second oblong holes 25 and the screws 26.

The rubbing belt 3 supported by the driving pulley 12 and the driven pulley 13 has a flat upper portion. The hopper 10 supplies the powder onto the flat upper portion of the rubbing belt 3. An outer surface of the rubbing belt 3 is made of a soft porous material, such as urethane sponge, and is configured to be able to hold the powder supplied from the hopper 10.

The hopper 10 includes a hopper box 30 configured to contain the powder therein, a hopper roller 31 disposed in the hopper box 30, and a hopper-roller rotating mechanism 34 configured to rotate the hopper roller 31. An example of a material of the hopper roller 31 is urethane sponge. The hopper-roller rotating mechanism 34 includes a motor and a torque transmission mechanism (e.g., a sprocket, a chain, etc.). The hopper-roller rotating mechanism 34 may be composed of a motor directly coupled to the hopper roller 31. A powder outlet 35 is formed in a bottom of the hopper box 30. The powder outlet 35 may be a plurality of through-holes or a slit.

The screen 1 is coupled to a negative electrode of the power supply (voltage application device) DC, and a stage 102 on which the object 100 is placed is coupled to a positive electrode of the power supply DC. The positive electrode of the power supply DC and the stage 102 are grounded. A high voltage is applied between the screen 1 and the stage 102 by the power supply DC, thereby forming an electrostatic field between the screen 1 and the object 100 on the stage 102.

When the pulley rotating mechanism 15 rotates the driving pulley 12, the rubbing belt 3 circulates while being supported by the driving pulley 12, the driven pulley 13, and the pressing head 5. The powder is supplied from the hopper 10 onto the outer surface of the rubbing belt 3 and is carried to the screen 1 by the rubbing belt 3. The powder is rubbed into the mesh la of the screen 1 by the rubbing belt 3 and pushed out from the opposite side of the screen 1. At this time, the powder is negatively charged by friction with the moving rubbing belt 3. Therefore, the powder is attracted to the grounded object 100 and adheres to a surface of the object 100, thus forming a film of uniform thickness on the object 100. Some types of powder are positively charged when rubbed into the mesh la of the screen 1 by the rubbing belt 3. When such powder is used, the screen 1 is coupled to the positive electrode of the power source DC, and the negative electrode of the power source DC and the stage 102 are grounded.

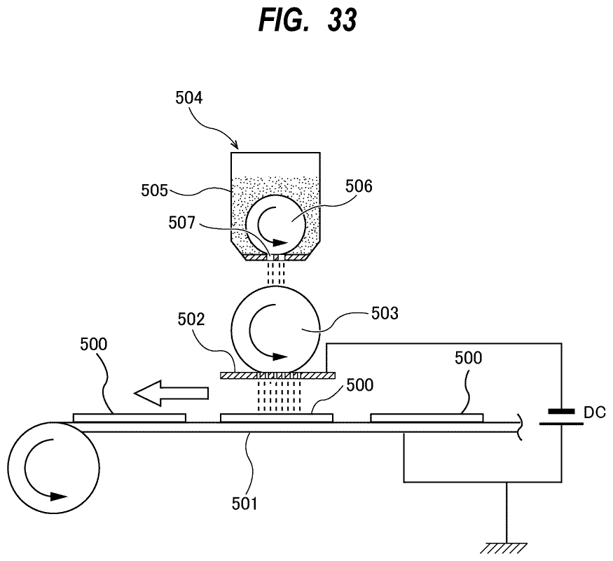

The rubbing belt 3 has a larger contact area with the screen 1 than a contact surface of the roll brush 503 shown in FIG. 33, and can therefore rub the powder into the screen 1 over a wider area. As a result, an efficiency of electrostatic application of the powder is improved, and the electrostatic application of the powder can be completed in a short time. In addition, since the contact area between the rubbing belt 3 and the screen 1 is large, the screen 1 is less likely to bend. As a result, a distance between the screen 1 and the object 100 can be uniform, and a uniform electrostatic field can be formed between the screen 1 and the object 100. Furthermore, a service life of the screen 1 is expected to increase.

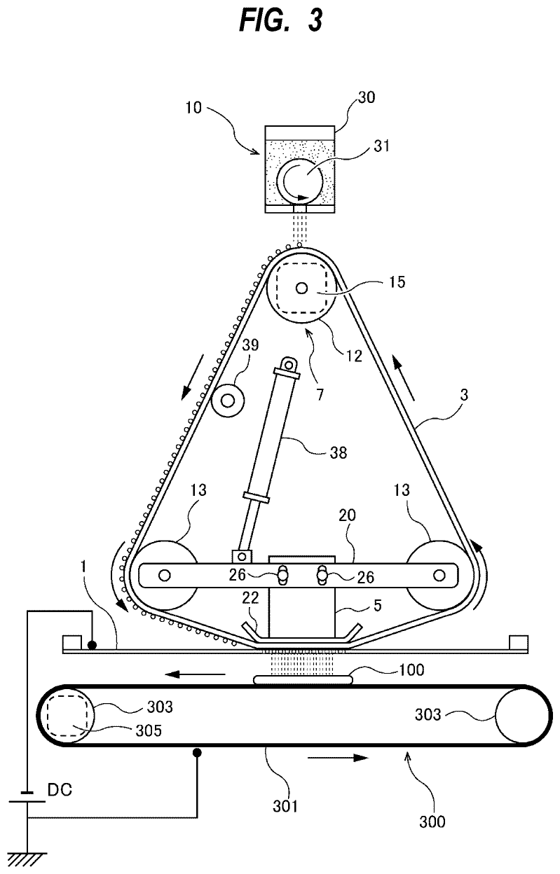

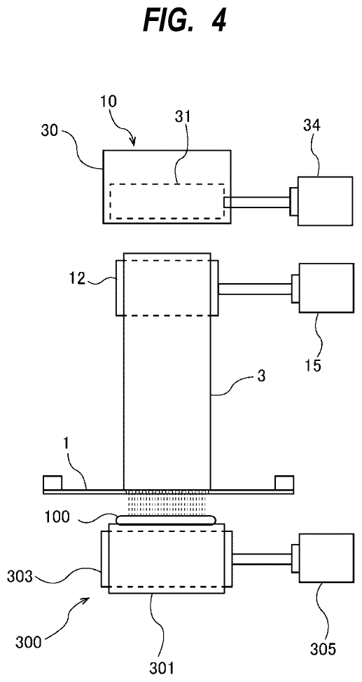

FIG. 3 is a front view showing another embodiment of the electrostatic film-forming apparatus, and FIG. 4 is a side view of the electrostatic film-forming apparatus shown in FIG. 3. Configuration and operation of this embodiment, which will not be specifically described, are the same as those of the embodiment described with reference to FIGS. 1 and 2, and therefore overlapping description will be omitted. The electrostatic film-forming apparatus of this embodiment includes a pressing regulation mechanism 38 configured to move the pressing head 5 in a direction toward the screen 1 and in a direction away from the screen 1. In the embodiment shown in FIG. 3, the pressing regulation mechanism 38 has an actuator, such as a fluid actuator (e.g., an air cylinder) or an electric actuator.

The pressing regulation mechanism 38 is coupled to the support member 20. Two driven pulleys 13 are rotatably attached to both ends of the support member 20. The pressing head 5 is held by the support member 20. The electrostatic film-forming apparatus further includes a tension pulley 39 that applies tension to the rubbing belt 3. The tension pulley 39 is pressed against the inner surface of the rubbing belt 3 by a spring (not shown). The driving pulley 12 is disposed at a position away from the two driven pulleys 13. The hopper 10 is disposed above a portion of the rubbing belt 3 supported by the driving pulley 12.

The object 100 is conveyed by a conveyor 300. The conveyor 300 includes a conveyor belt 301 on which the object 100 is placed, a plurality of belt rollers 303 that support the conveyor belt 301, and a belt driving motor 305 that is coupled to one of the plurality of belt rollers 303. The conveyor belt 301 on which the object 100 is placed is coupled to the positive pole of the power source DC. However, the configuration of the conveyor 300 is not limited to the embodiment shown in FIG. 3 as long as the conveyor 300 can convey the object 100 and can be electrically coupled to the positive pole (or negative pole) of the power source DC.

FIG. 3 shows a state in which the pressing regulation mechanism 38 pushes the pressing head 5 toward the screen 1 via the support member 20. When the object 100 is present just below the pressing head 5, the pressing head 5 presses the rubbing belt 3 against the screen 1, as shown in FIG. 3. The powder supplied from the hopper 10 is rubbed into the screen 1 by the rubbing belt 3, and travels toward the object 100 due to the electrostatic field formed between the screen 1 and the object 100, and adheres to the surface of the object 100.

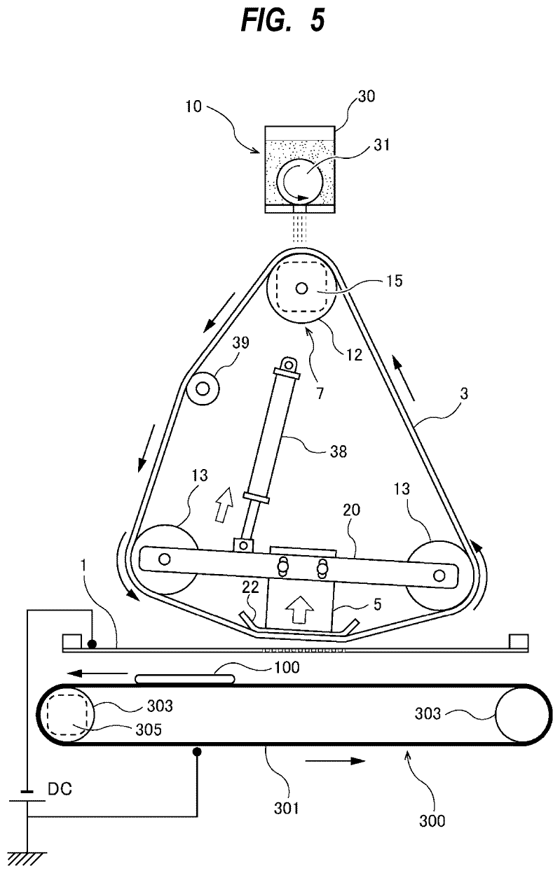

FIG. 5 is a diagram showing a state in which the pressing regulation mechanism 38 has moved the pressing head 5 in the direction away from the screen 1 via the support member 20. When the object 100 on the conveyor 300 is not just below the pressing head 5 as shown in FIG. 4, the pressing regulation mechanism 38 moves the pressing head 5 in the direction away from the screen 1 via the support member 20. The rubbing belt 3 is separated from the screen 1, so that the rubbing of the powder into the screen 1 is stopped.

In this way, the operations of the pressing regulation mechanism 38 can allow for intermittent application of the powder. In one embodiment, as shown in FIG. 3, continuous application of powder can be performed by maintaining a state in which the pressing regulation mechanism 38 pushes the pressing head 5 toward the screen 1 via the support member 20.

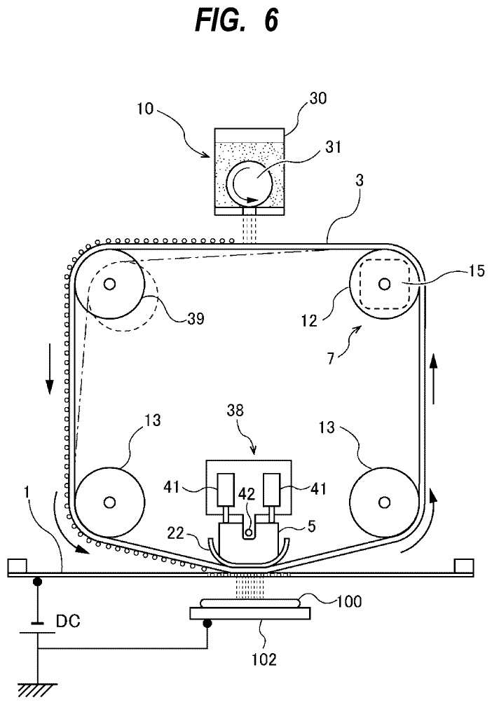

FIG. 6 is a front view showing another embodiment of the electrostatic film-forming apparatus. Configuration and operation of this embodiment, which will not be specifically described, are the same as those of the embodiment described with reference to FIGS. 1 and 2, and therefore overlapping description will be omitted. The electrostatic film-forming apparatus of this embodiment includes pressing regulation mechanism 38 configured to move the pressing head 5 in a direction toward the screen 1 and in a direction away from the screen 1. The pressing regulation mechanism 38 includes tilting actuators 41 configured to tilt the pressing head 5 with respect to the screen 1. More specifically, the pressing regulation mechanism 38 includes a pivot shaft 42 that supports the pressing head 5 and allows the pressing head 5 to be tiltable, and the two tilting actuators 41 arranged at both sides of the pivot shaft 42. The pressure plate 22 of the pressing head 5 is curved and protrudes toward the screen 1.

The pressing regulation mechanism 38 is disposed between the two driven pulleys 13. The driving pulley 12 and the tension pulley 39 are disposed at a position away from these driven pulleys 13. The tension pulley 39 is pressed against the rubbing belt 3 by a spring (not shown), thereby applying tension to the rubbing belt 3. The hopper 10 is disposed above a portion of the rubbing belt 3 supported by the tension pulley 39 and the driving pulley 12.

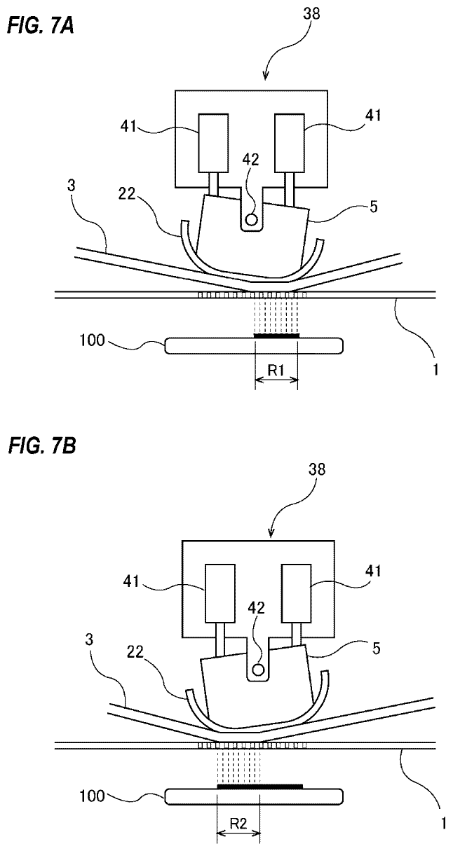

FIGS. 7A and 7B are diagrams for explaining operation of the two tilting actuators 41. The two tilting actuators 41 are configured to tilt the pressing head 5 in the longitudinal direction of the rubbing belt 3. Specifically, the two tilting actuators 41 tilt the pressing head 5 about the pivot shaft 42 extending perpendicular to the longitudinal direction of the rubbing belt 3.

In FIG. 7A, the two tilting actuators 41 tilt the pressing head 5 in a first direction. The pressing plate 22 of the tilted pressing head 5 presses the rubbing belt 3 against the screen 1, so that the powder adheres to a first range R1 of the object 100. Next, as shown in FIG. 7B, the two tilting actuators 41 tilt the pressing head 5 in a second direction opposite to the first direction. The pressing plate 22 of the tilted pressing head 5 presses the rubbing belt 3 against the screen 1, so that the powder adheres to a second range R2 of the object 100. As a result, the powder can be applied to the object 100 in a wide range including the first range R1 and the second range R2.

Specific examples of the tilting actuator include a fluid actuator (e.g., an air cylinder) and an electric actuator. In the embodiment shown in FIG. 6 and FIG. 7, the pressing regulation mechanism 38 has the two tilting actuators 41, while the configuration of the pressing regulation mechanism 38 is not limited to this embodiment as long as the pressing head 5 can be tilted along the longitudinal direction of the rubbing belt 3. For example, the pressing regulation mechanism 38 may have only one tilting actuator 41 adjacent to the pivot shaft 42.

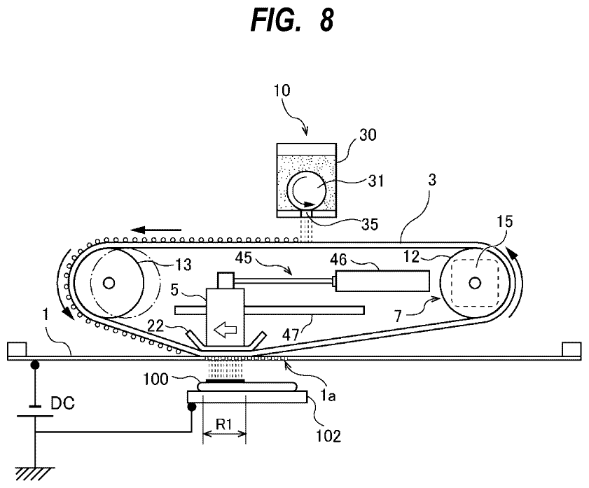

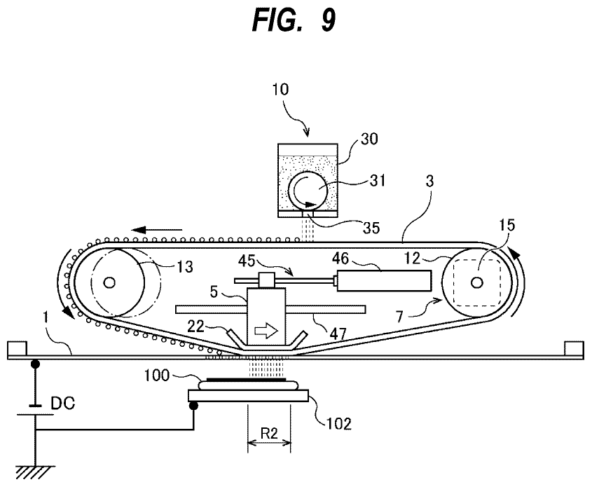

FIGS. 8 and 9 are front views showing another embodiment of the electrostatic film-forming apparatus. Configuration and operation of this embodiment, which will not be specifically described, are the same as those of the embodiment described with reference to FIGS. 1 and 2, and therefore overlapping description will be omitted. The electrostatic film-forming apparatus of this embodiment includes a translation mechanism 45 configured to move the pressing head 5 along the screen 1. The translation mechanism 45 is disposed so as to move the pressing head 5 relative to the rubbing belt 3. The position of the rubbing belt 3 is fixed.

The translation mechanism 45 has a translation actuator 46 coupled to the pressing head 5, and a linear guide 47 that movably supports the pressing head 5. The linear guide 47 is parallel to the screen 1 and extends in the longitudinal direction of the rubbing belt 3. Examples of the translation actuator 46 include a fluid actuator (e.g., an air cylinder) and an electric actuator.

As shown in FIGS. 8 and 9, the pressing head 5 is moved in the longitudinal direction of the rubbing belt 3 (the moving direction of the rubbing belt 3) by the translation actuator 46. The moving direction of the pressing head 5 is limited to a direction parallel to the screen 1 by the linear guide 47. In FIG. 8, the translation actuator 46 moves the pressing head 5 in a first direction. The pressing plate 22 of the pressing head 5 presses the rubbing belt 3 against the screen 1, and causes the powder to adhere to a first range R1 of the object 100.

Next, as shown in FIG. 9, the translation actuator 46 moves the pressing head 5 in a second direction opposite to the first direction. The pressing plate 22 of the pressing head 5 presses the rubbing belt 3 against the screen 1, and causes the powder to adhere to a second range R2 of the object 100. As a result, the powder can be applied to the object 100 in a wide range including the first range R1 and the second range R2. Furthermore, the application range of the powder can be changed according to a moving distance of the pressing head 5. Conventionally, in order to apply powder to a wide range, it was necessary to move a hopper together with a roll brush. According to this embodiment, it is only necessary to move the pressing head 5, and the position of the hopper 10 can be kept fixed. As a result, the mechanism of the entire apparatus can be simplified.

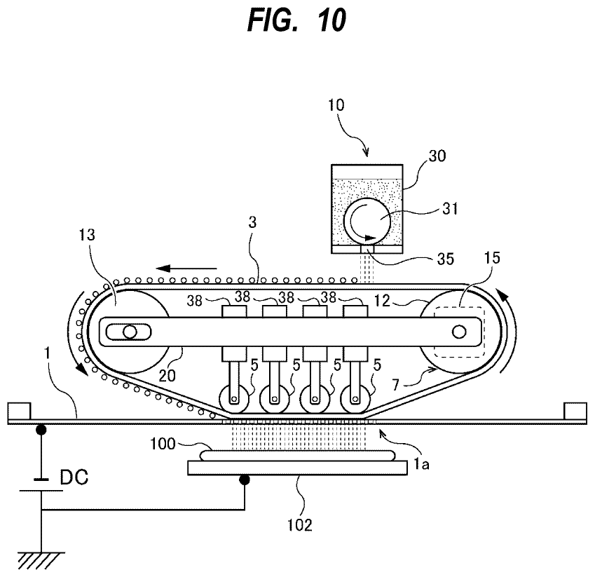

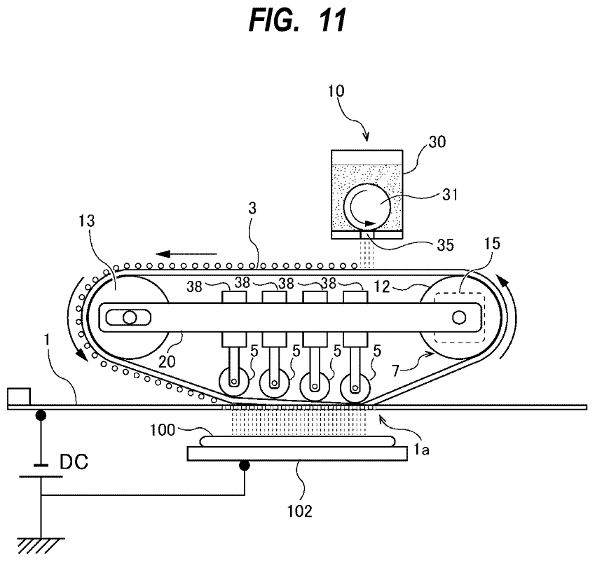

FIGS. 10 and 11 are front views showing another embodiment of the electrostatic film-forming apparatus. Configuration and operation of this embodiment, which will not be specifically described, are the same as those of the embodiment described with reference to FIGS. 1 and 2, and therefore overlapping description will be omitted. The electrostatic film-forming apparatus of this embodiment has a plurality of pressing heads 5 and a plurality of pressing regulation mechanisms 38 coupled to the plurality of pressing heads 5, respectively. The plurality of pressing regulation mechanisms 38 are fixed to the support member 20. Examples of each pressing regulation mechanism 38 include a fluid actuator (e.g., an air cylinder) and an electric actuator.

Each pressing head 5 is a pressing roller rotatably coupled to a corresponding pressing regulation mechanism 38. Therefore, the pressing head (pressing roller) 5 can come into rolling contact with the inner surface of the rubbing belt 3. The plurality of pressing regulation mechanisms 38 are configured to independently move the plurality of pressing heads 5 in a direction toward the screen 1 and in a direction away from the screen 1. For example, the pressing regulation mechanisms 38 can move the pressing heads 5 to different positions relative to the screen 1, so that the pressing heads 5 can press the rubbing belt 3 against the screen 1 with different pressing pressures. Furthermore, some of the pressing heads 5 may be separated from the rubbing belt 3, and the remaining pressing heads 5 may press the rubbing belt 3 against the screen 1.

In the example shown in FIG. 11, distances of the multiple pressing heads 5 from the screen 1 are gradually reduced along the moving direction of the rubbing belt 3. Typically, there is an tendency that an amount of powder rubbed into the screen 1 by the rubbing belt 3 is larger on an upstream side than on a downstream side of the rubbing belt 3 in its moving direction. Therefore, as shown in FIG. 11, by gradually reducing the distances of the multiple pressing heads 5 from the screen 1, the amount of powder rubbed into the screen 1 can be uniform in the moving direction of the rubbing belt 3. As a result, a powder film of uniform thickness can be formed on the object 100. Furthermore, the pressing pressure of the rubbing belt 3 against the screen 1 can be finely adjusted, so that the powder can be applied to the object 100 uniformly or with a desired thickness distribution.

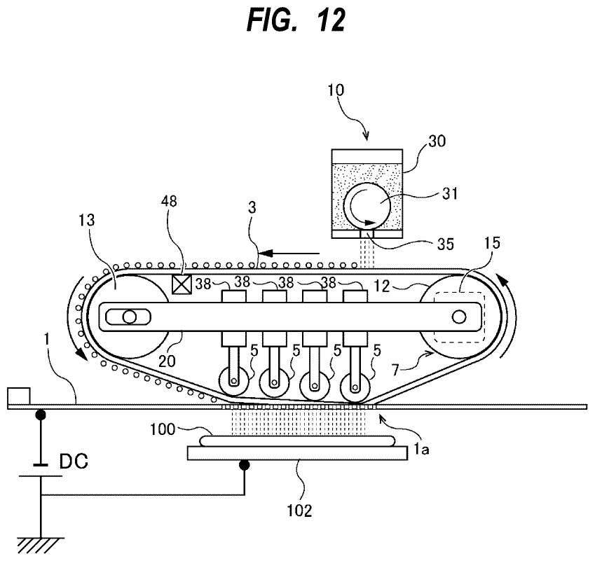

In one embodiment, as shown in FIG. 12, the electrostatic film-forming apparatus may further include a belt vibrating device 48 configured to vibrate the rubbing belt 3. The belt vibrating device 48 is in contact with a lower surface of the rubbing belt 3 at a position downstream of the hopper 10. The powder supplied onto the rubbing belt 3 from the hopper 10 is vibrated by the belt vibrating device 48, so that the powder can move into the rubbing belt 3. The powder is carried to a powder rubbing position by the rubbing belt 3, and the rubbing belt 3 is pressed against the screen 1 by the plurality of pressing heads 5.

In one embodiment, as shown in FIG. 12, the distances of the multiple pressing heads 5 from the screen 1 gradually decrease along the moving direction of the rubbing belt 3. The multiple pressing heads 5 thus arranged can first press the powder in a surface side of the rubbing belt 3 into the screen 1, and gradually press the powder in an inner side of the rubbing belt 3 into the screen 1. As a result, the film thickness of the powder can be adjusted.

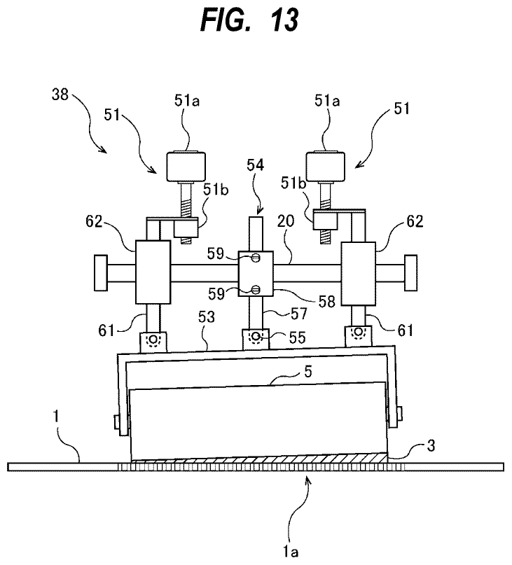

FIG. 13 is a diagram showing one embodiment of the pressing regulation mechanism 38 shown in FIG. 10. FIG. 13 illustrates the pressing regulation mechanism 38 as viewed from the moving direction of the rubbing belt 3. The pressing regulation mechanism 38 includes two tilting actuators 51 configured to tilt the pressing head 5 with respect to the screen 1. These tilting actuators 51 are configured to tilt the pressing head 5 in a width direction of the rubbing belt 3.

The pressing head (pressing roller) 5 is rotatably held by a head holder 53, and the two tilting actuators 51 are coupled to the head holder 53. The pressing regulation mechanism 38 includes a position regulating mechanism 54 disposed between the two tilting actuators 51. This position regulating mechanism 54 is coupled to the head holder 53 by a pivot shaft 55. The pivot shaft 55 extends in the longitudinal direction of the rubbing belt 3. The head holder 53 and the pressing head (pressing roller) 5 are capable of tilting in the width direction of the rubbing belt 3 (direction perpendicular to the longitudinal direction of the rubbing belt 3), while the head holder 53 and the pressing head (pressing roller) 5 are supported by the position regulating mechanism 54.

The position regulating mechanism 54 is fixed to the support member 20. The position regulating mechanism 54 can change the position of the pressing head (pressing roller) 5 with respect to the screen 1. Specifically, the position regulating mechanism 54 has a guide shaft 57 extending perpendicularly to the screen 1, a shaft holder 58 that holds the guide shaft 57, and screws 59 that fix a position of the guide shaft 57 with respect to the shaft holder 58. An end of the guide shaft 57 is coupled to the center of the head holder 53 via the pivot shaft 55.

The shaft holder 58 is fixed to the support member 20. When the screws 59 are tightened, the position of the guide shaft 57 relative to the shaft holder 58 is fixed. Therefore, the position of the pressing head (pressing roller) 5 relative to the screen 1 is fixed. When the screws 59 are loosened, the guide shaft 57 becomes movable relative to the shaft holder 58, and thus the position of the head holder 53 coupled to the guide shaft 57 and the position of the pressing head 5 relative to the screen 1 can be changed.

The two tilting actuators 51 are disposed at both sides of the guide shaft 57, and are coupled to the head holder 53 via slide shafts 61. The slide shafts 61 are movably supported by shaft guides 62 fixed to the support member 20. The two tilting actuators 51 can tilt the pressing head 5 in the width direction of the rubbing belt 3 around the pivot shaft 55. In this embodiment, each tilting actuator 51 is an electric actuator equipped with a servo motor 51a and a ball screw mechanism 51b, but may be another type of actuator. For example, each actuator may be a fluid actuator, such as an air cylinder.

According to this embodiment, the amount of powder applied in the width direction of the rubbing belt 3 can be regulated.

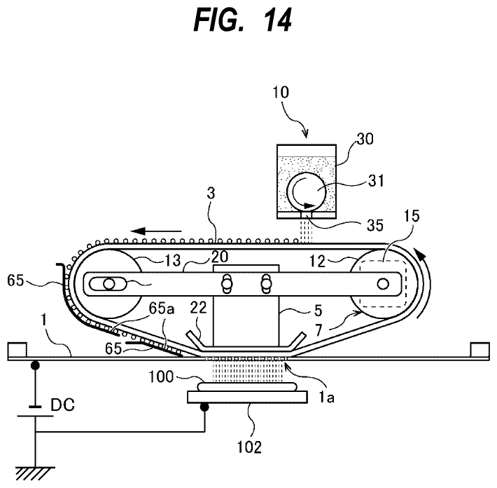

FIG. 14 is a front view showing another embodiment of the electrostatic film-forming apparatus. Configuration and operation of this embodiment, which will not be specifically described, are the same as those of the embodiment described with reference to FIGS. 1 and 2, and therefore overlapping description will be omitted. The electrostatic film-forming apparatus of this embodiment includes belt covers 65 that prevent the powder, supplied from the hopper 10 onto the rubbing belt 3, from falling from the rubbing belt 3. The belt covers 65 have powder guide surfaces 65a that extend along the outer surface of the rubbing belt 3.

The powder guide surfaces 65a of the belt covers 65 prevent the powder from falling from the rubbing belt 3, so that the rubbing belt 3 can stably carry the powder to the screen 1. As a result, the amount of powder rubbed into the screen 1 is stabilized, and a powder film of uniform thickness can be formed on the object 100.

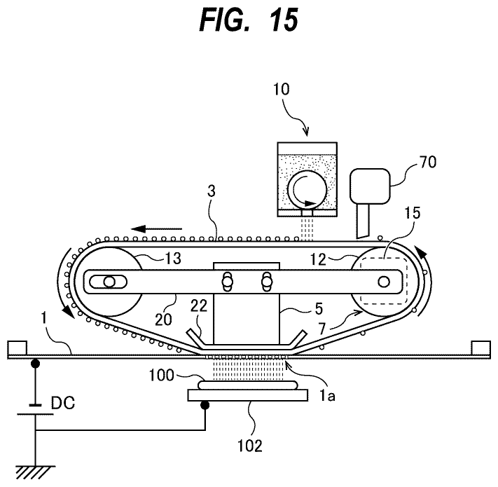

FIG. 15 is a front view showing another embodiment of the electrostatic film-forming apparatus. Configuration and operation of this embodiment, which will not be specifically described, are the same as those of the embodiment described with reference to FIGS. 1 and 2, and therefore overlapping description will be omitted. The electrostatic film-forming apparatus of this embodiment includes a vacuum suction device 70 configured to remove the powder from the rubbing belt 3 that has passed through the pressing head 5. The vacuum suction device 70 is disposed downstream of the pressing head 5 and upstream of the hopper 10 in the moving direction of the rubbing belt 3.

The vacuum suction device 70 can remove, from the rubbing belt 3, the powder that has not been pushed into the screen 1. After the rubbing belt 3 is cleaned by the vacuum suction device 70, the powder is supplied from the hopper 10 onto the rubbing belt 3. As a result, the amount of powder carried to the screen 1 by the rubbing belt 3 becomes stable.

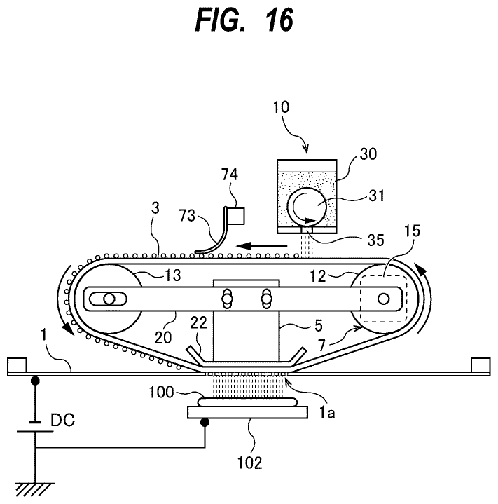

FIG. 16 is a front view showing another embodiment of the electrostatic film-forming apparatus. Configuration and operation of this embodiment, which will not be specifically described, are the same as those of the embodiment described with reference to FIGS. 1 and 2, and therefore overlapping description will be omitted. The electrostatic film-forming apparatus of this embodiment includes a powder leveling member 73 configured to level the powder that has been supplied from the hopper 10 onto the rubbing belt 3. The powder leveling member 73 is disposed above the rubbing belt 3. The powder leveling member 73 is held by a leveling-member holder 74. The powder leveling member 73 is disposed downstream of the hopper 10 and upstream of the pressing head 5 in the moving direction of the rubbing belt 3.

The powder leveling member 73 may be a flexible plate that contacts the outer surface of the rubbing belt 3. The powder leveling member 73 levels the powder supplied from the hopper 10 onto the rubbing belt 3, thereby stabilizing the amount of powder carried to the screen 1 by the rubbing belt 3.

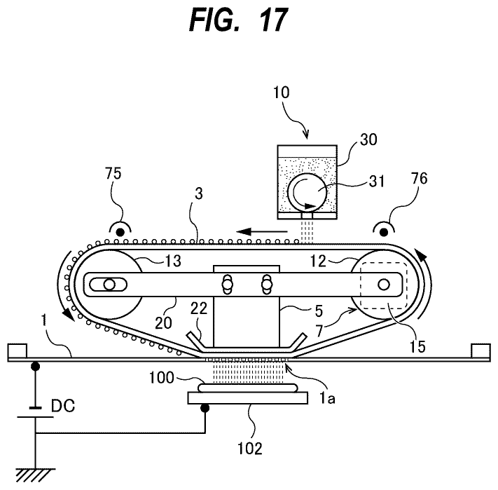

FIG. 17 is a front view showing another embodiment of the electrostatic film-forming apparatus. Configuration and operation of this embodiment, which will not be specifically described, are the same as those of the embodiment described with reference to FIGS. 1 and 2, and therefore overlapping description will be omitted. The electrostatic film-forming apparatus of this embodiment includes a first charge eliminator 75 configured to eliminate electric charge from the powder that has been supplied onto the rubbing belt 3 from the hopper 10. The first charge eliminator 75 is disposed downstream of the hopper 10 and upstream of the pressing head 5 in the moving direction of the rubbing belt 3. The first charge eliminator 75 is disposed so as to face the outer surface of the rubbing belt 3. The first charge eliminator 75 removes unnecessary electric charge from the powder. As a result, the electric charge of the powder due to the friction between the rubbing belt 3 and the screen 1 can be stable.

In one embodiment, as shown in FIG. 17, a second charge eliminator 76 may be further provided. The second charge eliminator 76 is disposed downstream of the pressing head 5 and upstream of the hopper 10 in the moving direction of the rubbing belt 3. The second charge eliminator 76 is disposed so as to face the outer surface of the rubbing belt 3. The second charge eliminator 76 can remove unnecessary electric charge from the surface of the rubbing belt 3 which has been charged by the friction with the screen 1.

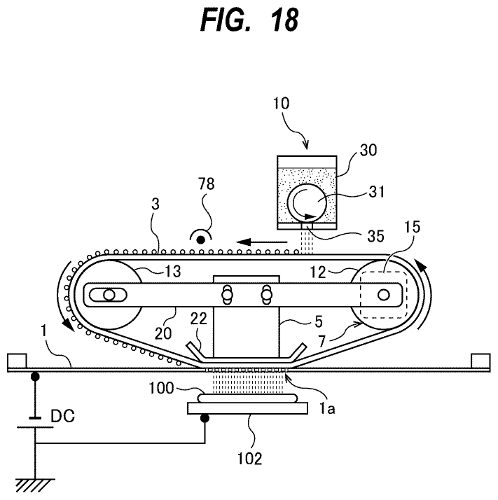

FIG. 18 is a front view showing another embodiment of the electrostatic film-forming apparatus. Configuration and operation of this embodiment, which will not be specifically described, are the same as those of the embodiment described with reference to FIGS. 1 and 2, and therefore overlapping description will be omitted. The electrostatic film-forming apparatus of this embodiment includes an electric-charge applying device 78 configured to apply electric charge to the powder that has been supplied from the hopper 10 onto the rubbing belt 3. The electric-charge applying device 78 is disposed downstream of the hopper 10 and upstream of the pressing head 5 in the moving direction of the rubbing belt 3. The electric-charge applying device 78 is disposed so as to face the outer surface of the rubbing belt 3. The electric-charge applying device 78 can assist in charging the powder by the friction between the rubbing belt 3 and the screen 1.

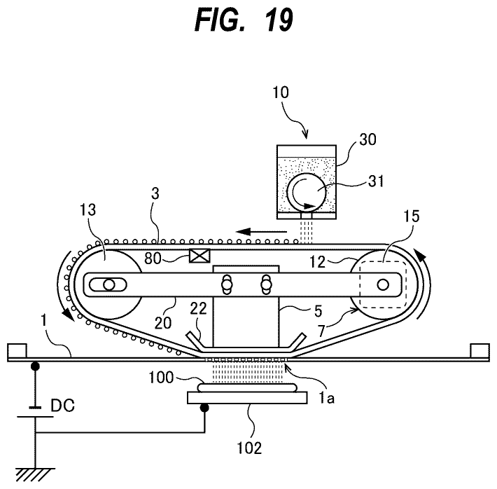

FIG. 19 is a front view showing another embodiment of the electrostatic film-forming apparatus. Configuration and operation of this embodiment, which will not be specifically described, are the same as those of the embodiment described with reference to FIGS. 1 and 2, and therefore overlapping description will be omitted. The electrostatic film-forming apparatus of this embodiment includes a belt vibrating device 80 configured to vibrate the rubbing belt 3 together with the powder that has been supplied from the hopper 10 onto the rubbing belt 3. The belt vibrating device 80 is disposed downstream of the hopper 10 and upstream of the pressing head 5 in the moving direction of the rubbing belt 3. Furthermore, the belt vibrating device 80 is in contact with the inner surface of the rubbing belt 3.

The belt vibration device 80 vibrates the rubbing belt 3, thereby allowing the powder to enter the inside of the rubbing belt 3. For example, the powder moves into the surface of the rubbing belt 3 by 1 mm to 2 mm. Therefore, the powder is less likely to fall from the rubbing belt 3, and is carried by the rubbing belt 3 to the screen 1. When the powder reaches the screen 1, the pressing head 5 presses the rubbing belt 3 against the screen 1. The powder is pushed out of the rubbing belt 3 and rubbed into the screen 1.

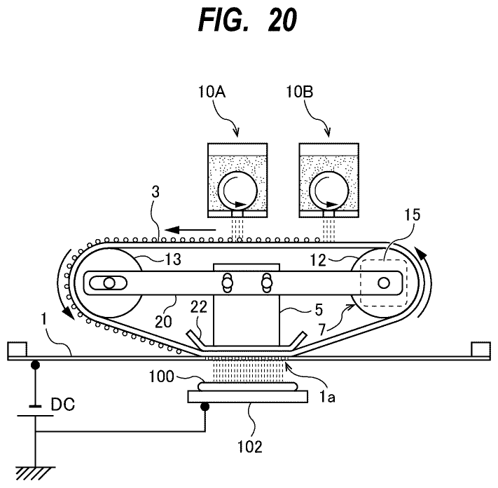

FIG. 20 is a front view showing another embodiment of the electrostatic film-forming apparatus. Configuration and operation of this embodiment, which will not be specifically described, are the same as those of the embodiment described with reference to FIGS. 1 and 2, and therefore overlapping description will be omitted. The electrostatic film-forming apparatus of this embodiment has a plurality of hoppers 10A, 10B. These hoppers 10A, 10B are arranged above a flat upper part of the rubbing belt 3. The hoppers 10A, 10B are arranged along the moving direction of the rubbing belt 3.

Powders contained in the plurality of hoppers 10A, 10B may be the same type of powder or different types of powder. When the same type of powder is contained, an amount of powder supplied can be increased, so that a thick powder film can be formed on the object 100. If necessary, only one of the hoppers 10A, 10B may be operated.

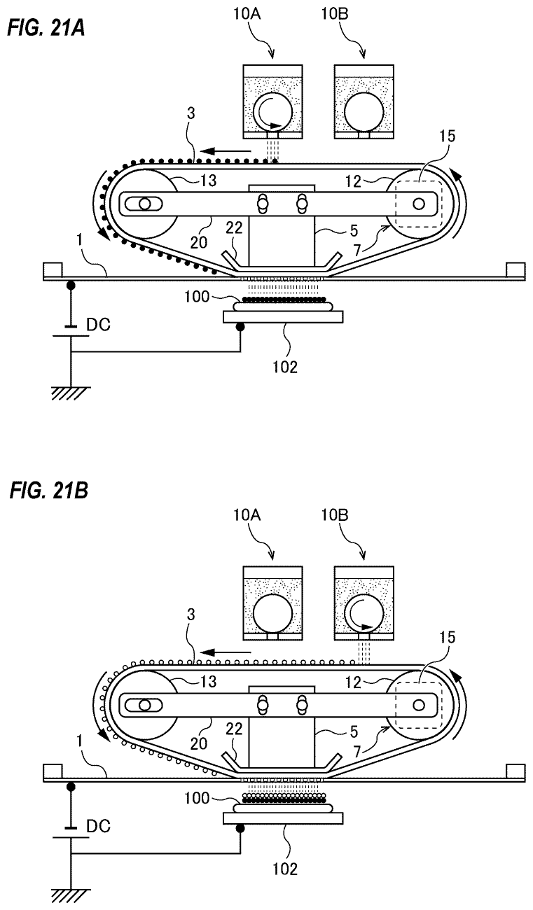

When different types of powders are stored, the different powders can be applied to the object 100 to form multilayered films made of different powders. For example, as shown in FIG. 21A, first powder is supplied to the rubbing belt 3 from one of the hoppers 10A and 10B, and the powder is rubbed into the screen 1 by the rubbing belt 3, thereby forming a first film of the first powder on the object 100. Next, as shown in FIG. 21B, second powder is supplied to the rubbing belt 3 from the other of the hoppers 10A and 10B, and the powder is rubbed into the screen 1 by the rubbing belt 3, thereby forming a second film of the second powder on the first film. Two hoppers 10A and 10B are provided in FIG. 20 and FIG. 21, while three or more hoppers may be provided.

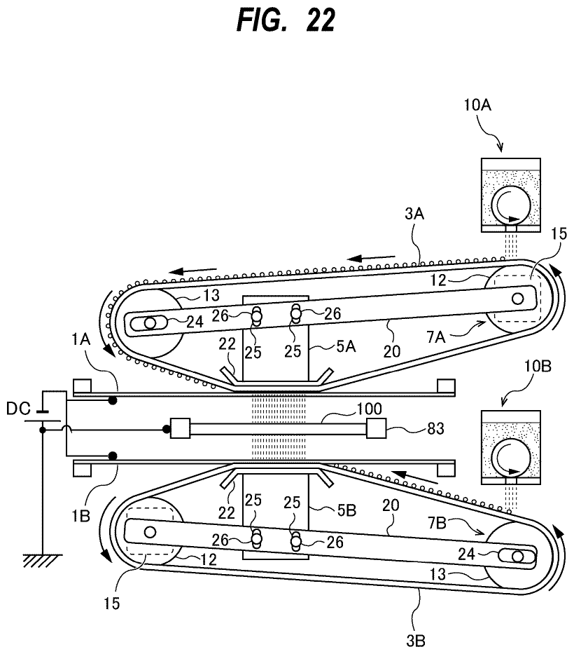

FIG. 22 is a front view showing another embodiment of the electrostatic film-forming apparatus. Configuration and operation of this embodiment, which will not be specifically described, are the same as those of the embodiment described with reference to FIGS. 1 and 2, and therefore overlapping description will be omitted. The electrostatic film-forming apparatus of this embodiment includes a first screen 1A and a second screen 1B arranged above and below the object 100, a first rubbing belt 3A and a second rubbing belt 3B arranged above and below the object 100, a first pressing head 5A and a second pressing head 5B arranged above and below the object 100, a first belt moving mechanism 7A and a second belt moving mechanism 7B arranged above and below the object 100, and a first hopper 10A and a second hopper 10B arranged above the first rubbing belt 3A and the second rubbing belt 3B.

The object 100 is horizontally held by a holding member 83. The negative pole of the power source DC is coupled to the first screen 1A and the second screen 1B, and the positive pole of the power source DC is coupled to the holding member 83 and is grounded. The first screen 1A and the second screen 1B are arranged symmetrically with respect to the object 100. The first rubbing belt 3A and the second rubbing belt 3B are also arranged symmetrically with respect to the object 100. The first hopper 10A is arranged above the first rubbing belt 3A, and the second hopper 10B is arranged above the second rubbing belt 3B. According to this embodiment, powder can be applied to both sides of the object 100 at the same time.

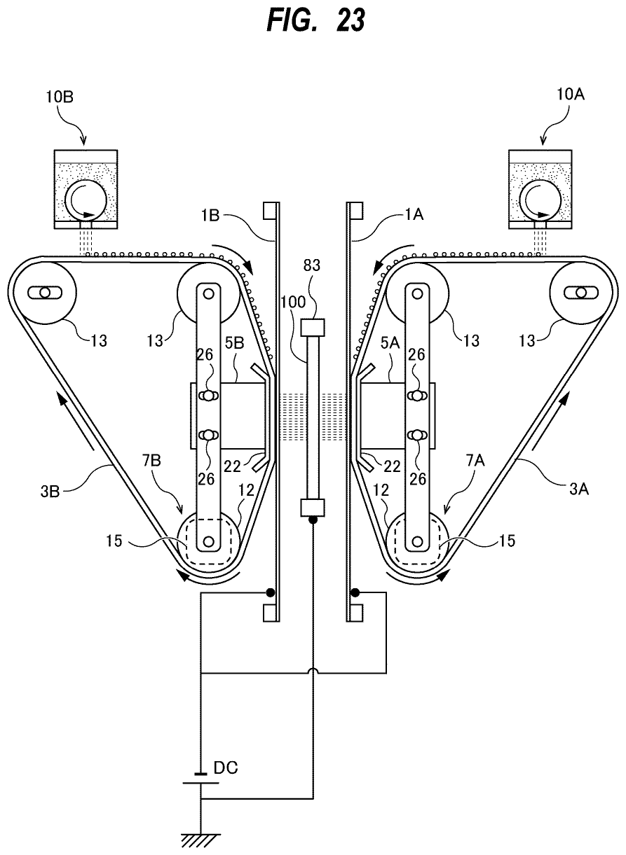

FIG. 23 is a front view showing another embodiment of the electrostatic film-forming apparatus. Configuration and operation of this embodiment, which will not be specifically described, are the same as those of the embodiment described with reference to FIGS. 1 and 2, and therefore overlapping description will be omitted. The electrostatic film-forming apparatus of this embodiment includes a first screen 1A and a second screen 1B arranged at both sides of the object 100, a first rubbing belt 3A and a second rubbing belt 3B arranged at both sides of the object 100, a first pressing head 5A and a second pressing head 5B arranged at both sides of the object 100, a first belt moving mechanism 7A and a second belt moving mechanism 7B arranged at both sides of the object 100, and a first hopper 10A and a second hopper 10B arranged above the first rubbing belt 3A and the second rubbing belt 3B.

The object 100 is held vertically by a holding member 83. The negative pole of the power source DC is coupled to the first screen 1A and the second screen 1B, and the positive pole of the power source DC is coupled to the holding member 83 and is grounded. The first screen 1A and the second screen 1B are arranged symmetrically with respect to the object 100. The first rubbing belt 3A and the second rubbing belt 3B are also arranged symmetrically with respect to the object 100. The first hopper 10A is arranged above the first rubbing belt 3A, and the second hopper 10B is arranged above the second rubbing belt 3B. According to this embodiment, powder can be applied to both sides of the object 100 at the same time.

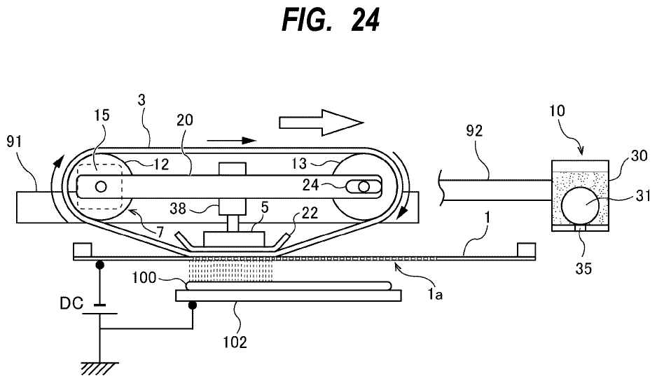

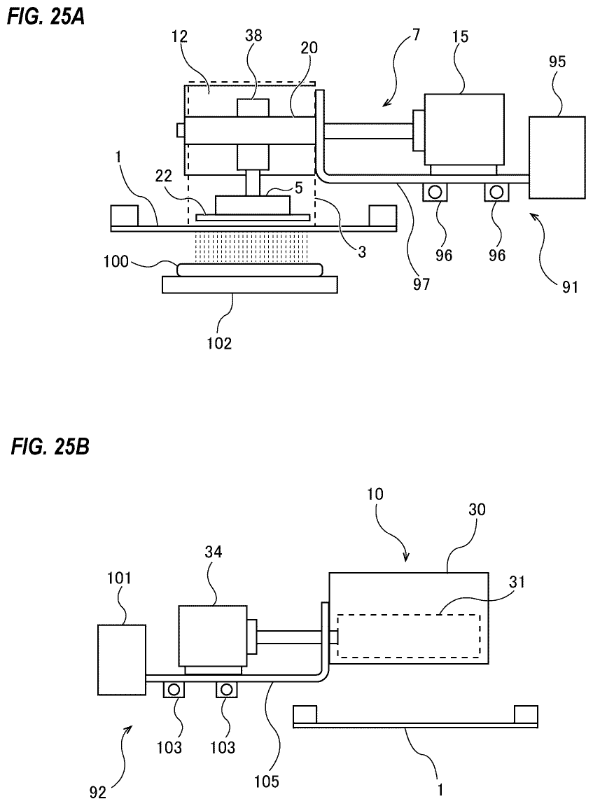

FIG. 24 is a front view showing another embodiment of the electrostatic film-forming apparatus, and FIG. 25 is a side view of the electrostatic film-forming apparatus shown in FIG. 24. Configuration and operation of this embodiment, which will not be specifically described, are the same as those of the embodiment described with reference to FIGS. 1 and 2, and therefore overlapping description will be omitted. The electrostatic film-forming apparatus of this embodiment includes a first moving mechanism 91 configured to move the rubbing belt 3, the pressing head 5, and the belt moving mechanism 7 together parallel to the screen 1, and a second moving mechanism 92 configured to move the hopper 10 parallel to the screen 1.

The electrostatic film-forming apparatus of this embodiment includes a pressing regulation mechanism 38 coupled to the pressing head 5. This pressing regulation mechanism 38 is configured to move the pressing head 5 in a direction toward the screen 1 and a direction away from the screen 1. The pressing regulation mechanism 38 is fixed to the support member 20 that rotatably supports the driving pulley 12 and the driven pulley 13 (tension pulley). When the powder is to be rubbed into the screen 1, the pressing regulation mechanism 38 presses the rubbing belt 3 against the screen 1 with the pressing plate 22. When the powder is not rubbed into the screen 1, the pressing regulation mechanism 38 elevates the pressing plate 22 to allow the rubbing belt 3 to move away from the screen 1.

As shown in FIG. 25A, the first moving mechanism 91 has a first linear actuator 95 and first linear guides 96. The rubbing belt 3, the pressing head 5, and the belt moving mechanism 7 (including the pulley rotating mechanism 15, the driving pulley 12, and the driven pulley 13) are coupled to the first linear actuator 95 and the first linear guides 96. The first linear actuator 95 and the first linear guides 96 extend parallel to the screen 1. A first movable pedestal 97 on which the pulley rotating mechanism 15 is installed is supported movably by the first linear guides 96. The first linear actuator 95 is coupled to the first movable pedestal 97 and moves the first movable pedestal 97 along the first linear guides 96.

The pulley rotating mechanism 15 is coupled to the driving pulley 12. The pulley rotating mechanism 15 and the support member 20 are fixed to the first movable pedestal 97. Therefore, the first linear actuator 95 can move the pulley rotating mechanism 15, the support member 20, the pressing regulation mechanism 38, the driving pulley 12, the driven pulley 13 (tension pulley), and the rubbing belt 3 along the first linear guides 96 (i.e., parallel to the screen 1). Examples of the first linear actuator 95 include an electric linear actuator (e.g., a ball-screw actuator or a belt actuator) and a fluid linear actuator (e.g., an air cylinder).

As shown in FIG. 25B, the second moving mechanism 92 has a second linear actuator 101 and second linear guides 103 coupled to the hopper 10. The second linear actuator 101 and the second linear guides 103 extend parallel to the screen 1. A second movable pedestal 105 on which the hopper-roller rotating mechanism 34 is installed is movably supported by the second linear guides 103. The second linear actuator 101 is coupled to the second movable pedestal 105 and moves the second movable pedestal 105 along the second linear guides 103.

The hopper-roller rotating mechanism 34 is coupled to the hopper roller 31. The hopper-roller rotating mechanism 34 and the hopper box 30 are fixed to the second movable pedestal 105. Therefore, the second linear actuator 101 can move the hopper 10 including the hopper-roller rotating mechanism 34, the hopper roller 31, and the hopper box 30 along the second linear guides 103 (i.e., parallel to the screen 1). Examples of the second linear actuator 101 include an electric linear actuator (e.g., a ball-screw actuator or a belt actuator) and a fluid linear actuator (e.g., an air cylinder).

The first moving mechanism 91 and the second moving mechanism 92 are configured to operate independently. Therefore, the first moving mechanism 91 can move the rubbing belt 3 parallel to the screen 1 independently of the hopper 10. Similarly, the second moving mechanism 92 can move the hopper 10 parallel to the screen 1 independently of the rubbing belt 3.

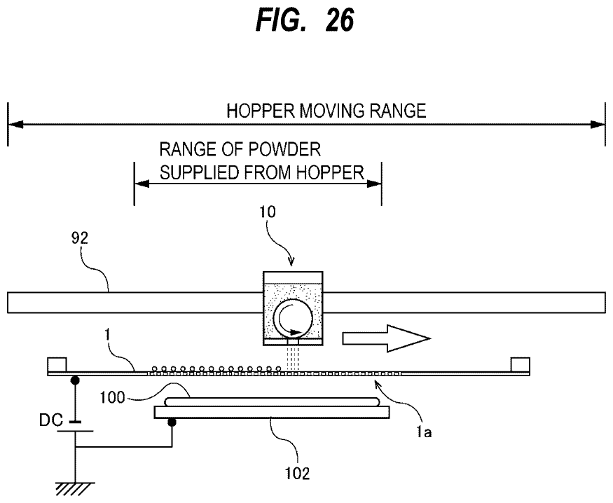

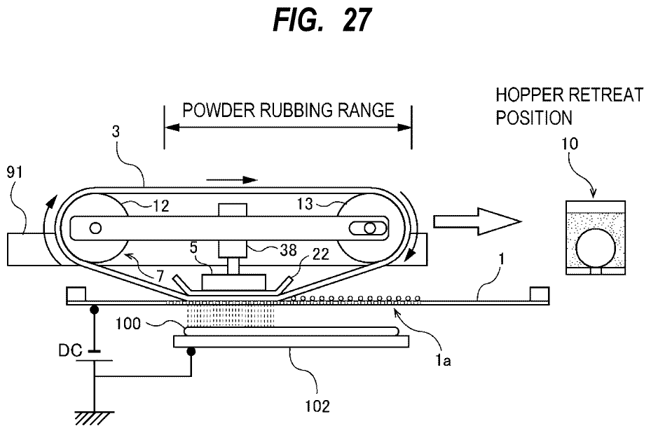

FIG. 26 is a diagram for explaining the operation of the second moving mechanism 92 which moves the hopper 10 above the screen 1, and FIG. 27 is a diagram for explaining the operation of the first moving mechanism 91 which moves the rubbing belt 3, the pressing head 5, and the belt moving mechanism 7 along the screen 1. In this embodiment, the powder is supplied from the hopper 10 onto the screen 1.

As shown in FIG. 26, first, the second moving mechanism 92 moves the hopper 10 above the screen 1 while the hopper 10 supplies the powder onto the screen 1. Before the second moving mechanism 92 moves the hopper 10 above the screen 1, the first moving mechanism 91 moves the rubbing belt 3, the pressing head 5, and the belt moving mechanism 7 out of the screen 1. The second moving mechanism 92 moves the hopper 10 within a desired range, so that the hopper 10 can supply the powder to the desired range of the screen 1. In one embodiment, the hopper 10 may repeatedly supply the powder onto the screen 1 while the second moving mechanism 92 is moving the hopper 10 over the screen 1 multiple times.

As shown in FIG. 27, when the supply of the powder from the hopper 10 to the screen 1 is terminated, the second moving mechanism 92 moves the hopper 10 to a retreat position outside the screen 1. Next, the first moving mechanism 91 moves the rubbing belt 3, the pressing head 5, and the belt moving mechanism 7 over the screen 1. Then, while the first moving mechanism 91 moves the rubbing belt 3, the pressing head 5, and the belt moving mechanism 7 parallel to the screen 1, the rubbing belt 3 rubs the powder on the screen 1 into the mesh 1a of the screen 1. The powder adheres to the object 100 by the electrostatic force generated between the screen 1 and the object 100. This embodiment can make it possible to apply the powder to a wide range of the object 100.

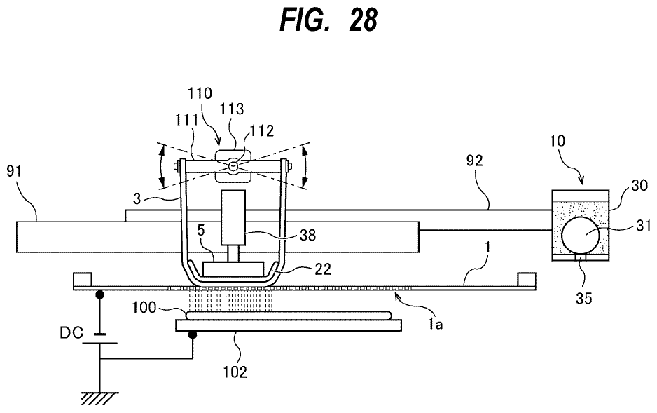

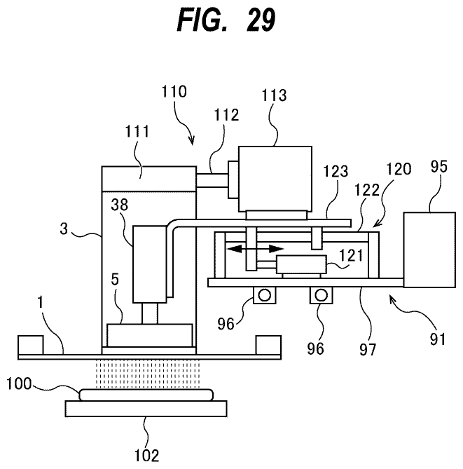

FIG. 28 is a front view showing another embodiment of the electrostatic film-forming apparatus, and FIG. 29 is a side view of the electrostatic film-forming apparatus shown in FIG. 28. Configuration and operation of this embodiment, which will not be specifically described, are the same as those of the embodiment described with reference to FIGS. 24 to 27, and therefore overlapping description will be omitted. In this embodiment, a rubbing belt 3 is a belt having its ends. A belt moving mechanism 110 is configured to reciprocate the rubbing belt 3 in its longitudinal direction.

The belt moving mechanism 110 includes a swing arm 111 that holds both ends of the rubbing belt 3, a pivot shaft 112 fixed to the center of the swing arm 111, and a swing motor 113 coupled to the pivot shaft 112. The swing motor 113 rotates the pivot shaft 112 clockwise and counterclockwise alternately to rotate the swing arm 111 by a predetermined angle around the pivot shaft 112. This movement of the swing arm 111 causes the rubbing belt 3, held by both ends of the swing arm 111, to reciprocate in the longitudinal direction of the rubbing belt 3.

The pressing head 5 is coupled to pressing regulation mechanism 38. The pressing regulation mechanism 38 is configured to move the pressing head 5 in a direction toward the screen 1 and a direction away from the screen 1. Examples of the pressing regulation mechanism 38 include a fluid actuator (e.g., an air cylinder) and an electric actuator. The rubbing belt 3 is in sliding contact with the screen 1 while being pressed against the mesh la of the screen 1 by the pressing plate 22 of the pressing head 5.

As shown in FIG. 29, the electrostatic film-forming apparatus further includes, in addition to the first moving mechanism 91 and the second moving mechanism 92, a third moving mechanism 120 configured to move the rubbing belt 3, the pressing head 5, and the belt moving mechanism 7 in a width direction of the rubbing belt 3. The width direction of the rubbing belt 3 is parallel to the screen 1 and perpendicular to the direction in which the first moving mechanism 91 moves the rubbing belt 3, the pressing head 5, and the belt moving mechanism 110.

The third moving mechanism 120 has a third linear actuator 121 and a third linear guide 122 arranged on the first movable pedestal 97, and a third movable pedestal 123 held by the third linear guide 122. The swing motor 113 is installed on the third movable pedestal 123. The pressing regulation mechanism 38 is fixed to the third movable pedestal 123. The third linear guide 122 extends in the width direction of the rubbing belt 3 and allows the third movable pedestal 123 to move in the width direction of the rubbing belt 3. The third linear actuator 121 is coupled to the third movable pedestal 123 and is configured to move the third movable pedestal 123 as shown by arrow. With this configuration, the third linear actuator 121 can move the third movable pedestal 123, the swing motor 113, the pivot shaft 112, the swing arm 111, the rubbing belt 3, the pressing regulation mechanism 38, and the pressing head 5 in the width direction of the rubbing belt 3.

The operations of supplying the powder and rubbing the powder in this embodiment are the same as those in the embodiments described with reference to FIGS. 26 and 27. In this embodiment, the third moving mechanism 120 can move the rubbing belt 3 in its width direction, so that the powder application range can be further expanded.

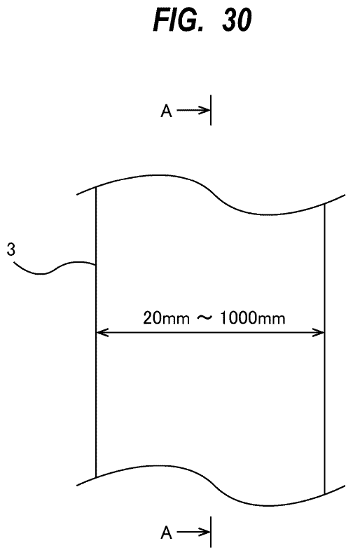

FIG. 30 is a front view showing one embodiment of the rubbing belt 3 described with reference to FIGS. 1 to 29, and FIG. 31 is a cross-sectional view taken along line A-A in FIG. 30. The rubbing belt 3 has a rubbing layer 131 for rubbing the powder into the screen 1, a core layer 132 bonded to the rubbing layer 131, and a drive transmission layer 133 bonded to the core layer 132. The core layer 132 is sandwiched between the rubbing layer 131 and the drive transmission layer 133. The drive transmission layer 133 is a layer in contact with the driving pulley 12. The rubbing layer 131, the core layer 132, and the drive transmission layer 133 are bonded together with an adhesive that maintains its flexibility. For example, a rubber-based adhesive, an epoxy-based adhesive, a silicone-based adhesive, or the like that can exert adhesive strength while maintaining flexibility can be used.

The rubbing layer 131 is made of a porous material capable of retaining the powder therein. For example, open-cell urethane sponge, which has good powder retention, can be used as the material for the rubbing layer 131. Other examples include velvet cloth and thin skin with a large surface roughness. The core layer 132 is made of a material that has high strength, excellent flexibility, and high mechanical strength. For example, aramid-based blended fibers can be used for the core layer 132. As another example, the core layer 132 may be made by weaving fibers, such as nylon, polyester, cotton, and acrylic resin into a net shape. The drive transmission layer 133 is made of a material that is highly resistant to wear and toughness, flexible, and has high contact friction with the driving pulley 12. For example, nitrile rubber can be used as the material for the drive transmission layer 133.

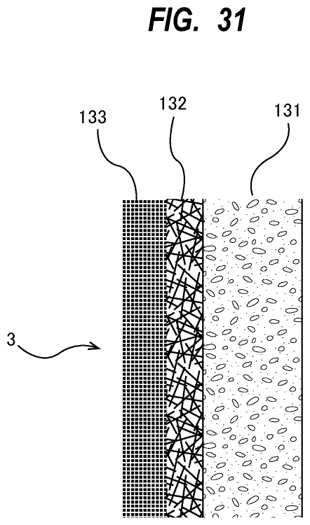

The width and thickness of the rubbing belt 3 are not particularly limited. For example, the width of the rubbing belt 3 is within a range of 20 mm to 1000 mm, and the thickness of the rubbing belt 3 is within a range of 4 mm to 20 mm. The thickness of the rubbing layer 131 is within a range of 3 mm to 10 mm, for example. In one embodiment, as shown in FIG. 31, the thickness of the rubbing layer 131 is larger than the thickness of the core layer 132 and the thickness of the drive transmission layer 133 so that the rubbing layer 131 can retain the powder therein.

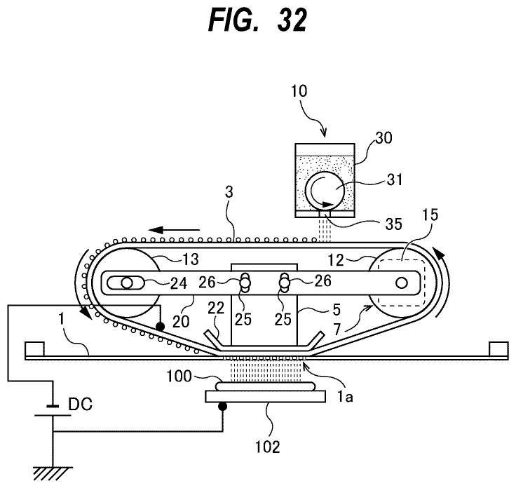

The rubbing belt 3 is made of an insulating material and has insulating properties. When the screen 1 is arranged close to the object 100, the screen 1 is made of an insulating material. In that case, the rubbing belt 3 is made of a conductive material and is coupled to the power source DC as shown in FIG. 32. The rubbing belt 3 can be made conductive by mixing a conductive material (e.g., conductive powder) into each of the above-mentioned layers constituting the rubbing belt 3.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

What is claimed is:

1. An electrostatic film-forming apparatus for depositing powder onto an object by electrostatic force, comprising:
a screen having a mesh formed thereon;
a rubbing belt configured to rub the powder into the screen;
a pressing head configured to press the rubbing belt against the screen;
a belt moving mechanism configured to move the rubbing belt in its longitudinal direction;
a power source configured to apply a voltage between the screen and the object; and
a hopper configured to supply the powder to the rubbing belt or the screen.

2. The electrostatic film-forming apparatus according to claim 1, wherein the rubbing belt is an endless belt, and the belt moving mechanism has a driving pulley and a driven pulley that support the rubbing belt, and a pulley rotating mechanism configured to rotate the driving pulley.

3. The electrostatic film-forming apparatus according to claim 1, wherein the hopper is located above the rubbing belt and is arranged to supply the powder onto the rubbing belt.

4. The electrostatic film-forming apparatus according to claim 3, further comprising a powder leveling member configured to level the powder supplied from the hopper to the rubbing belt.

5. The electrostatic film-forming apparatus according to claim 3, further comprising a belt vibrating device configured to vibrate the rubbing belt together with the powder supplied from the hopper to the rubbing belt.

6. The electrostatic film-forming apparatus according to claim 3, further comprising a belt cover configured to prevent the powder, supplied from the hopper to the rubbing belt, from falling from the rubbing belt, the belt cover having a powder guide surface extending along an outer surface of the rubbing belt.

7. The electrostatic film-forming apparatus according to claim 3, further comprising a charge eliminator configured to eliminate electric charge from the powder supplied from the hopper to the rubbing belt.

8. The electrostatic film-forming apparatus according to claim 3, further comprising an electric-charge applying device configured to apply electric charge to the powder supplied from the hopper to the rubbing belt.

9. The electrostatic film-forming apparatus according to claim 1, further comprising a vacuum suction device configured to remove the powder from the rubbing belt that has passed through the pressing head.

10. The electrostatic film-forming apparatus according to claim 1, further comprising a pressing regulation mechanism configured to move the pressing head in a direction toward the screen and in a direction away from the screen.

11. The electrostatic film-forming apparatus according to claim 10, wherein the pressing regulation mechanism includes a tilting actuator configured to tilt the pressing head relative to the screen.

12. The electrostatic film-forming apparatus according to claim 11, wherein the tilting actuator is configured to tilt the pressing head in the longitudinal direction of the rubbing belt.

13. The electrostatic film-forming apparatus according to claim 11, wherein the tilting actuator is configured to tilt the pressing head in a width direction of the rubbing belt.

14. The electrostatic film-forming apparatus according to claim 10, wherein the pressing head comprises a plurality of pressing heads, and the pressing regulation mechanism comprises a plurality of pressing regulation mechanisms coupled to the plurality of pressing heads, respectively.

15. The electrostatic film-forming apparatus according to claim 1, further comprising a translation mechanism configured to move the pressing head along the screen, the translation mechanism being disposed so as to move the pressing head relative to the rubbing belt.

16. The electrostatic film-forming apparatus according to claim 1, wherein:
the screen comprises a first screen and a second screen arranged above and below the object;
the rubbing belt comprises a first rubbing belt and a second rubbing belt arranged above and below the object;
the pressing head comprises a first pressing head and a second pressing head arranged above and below the object;
the belt moving mechanism comprises a first belt moving mechanism and a second belt moving mechanism arranged above and below the object; and
the hopper comprises a first hopper and a second hopper arranged above the first rubbing belt and the second rubbing belt.

17. The electrostatic film-forming apparatus according to claim 1, wherein:
the screen comprises a first screen and a second screen arranged at both sides of the object;
the rubbing belt comprises a first rubbing belt and a second rubbing belt arranged at both sides of the object;
the pressing head comprises a first pressing head and a second pressing head arranged at both sides of the object;
the belt moving mechanism comprises a first belt moving mechanism and a second belt moving mechanism arranged at both sides of the object; and
the hopper comprises a first hopper and a second hopper arranged above the first rubbing belt and the second rubbing belt.

18. The electrostatic film-forming apparatus according to claim 1, wherein the hopper comprises a plurality of hoppers disposed above the rubbing belt.

19. The electrostatic film-forming apparatus according to claim 1, further comprising:
a first moving mechanism configured to move the rubbing belt, the pressing head, and the belt moving mechanism together parallel to the screen; and
a second moving mechanism configured to move the hopper parallel to the screen.

20. The electrostatic film-forming apparatus according to claim 1, wherein the rubbing belt comprises a belt having ends, and the belt moving mechanism is configured to reciprocate the rubbing belt in its longitudinal direction.
